(19) United States
(12) Patent Application Publication
(10) Pub. No.: US 2002/0134381 A1
(43) Pub. Date: Sep. 26, 2002

(54) Individual protective device, in particular against nbc attacks

(76) Inventors: Jean-Philippe Bonhomme, Montigny-Le-Bretonneux (FR); Jean-Claude Fauveau, Bu (FR); Dominique Lemasson, Les Clayes-Sous-Bois (FR)

Correspondence Address: LARSON & TAYLOR, PLC, 1199 NORTH FAIRFAX STREET, SUITE 900, ALEXANDRIA, VA, 22314, US

(21) Appl. No.: 09/979,635

(22) PCT Filed: Mar. 26, 2001
(86) PCT No.: PCT/FR01/00905

(51) Int. Cl. A62B 17/04; A62B 18/00; A62B 18/02

(52) U.S. Cl. 128/201.24; 128/205.25

(57) ABSTRACT

A device for breathing and possibly providing NBC protection, the device comprising a mouth-and-nose mask with a breathing gas admission and a breathe-out outlet provided with a breathe-out check valve and with a breathing gas coupling piece carried by an element which is distinct from the mask and worn directly on the head. The coupling piece includes a passage that is connectable in airtight manner to the mouth-and-nose mask feed and a lateral pipe (34) taking the connection with the breathing gas feed (32) rearwards.

The present invention relates to devices for protecting individuals against oxygen deficiency, and possibly also nuclear, biological, or chemical (NBC) attack, and intended in particular for the crew members of military aircraft. Such devices must protect not only the respiratory tract, but also the entire head, and for this purpose they generally comprise a hood which terminates in a neck seal providing continuity with a garment.

The invention relates in particular to a device comprising both a hoop secured to a hood or a helmet and a face cover provided with fasteners enabling it to be fixed in such a manner as to provide a leaktight connection with the hoop, and provided with a pipe for feeding breathing gas to the face cover or directly to a mouth-and-nose mask contained inside the face cover or connected thereto.

It is desirable to have equipment that is easily adapted to various types of aircraft and mission. Unfortunately, the specifications that need to be satisfied change with circumstances. When a device is for use by a helicopter crew, the breathing gas is generally filtered air delivered by a blower and which is supplied to the wearer only when there is an NBC threat, the wearer breathing surrounding air directly under other circumstances. When the device is intended for a fighter pilot, breathing gas is supplied to a mask, and at high altitude the pilot receives oxygen diluted by ambient air and coming from a seat regulator or from a regulator fixed to the mouth-and-nose mask and fed with filtered air and with oxygen.

A device for full NBC protection is uncomfortable. Because of the presence of a hoop to and for which the face cover is easily secured and released (patent application EP 0 885 632), crew can avoid wearing the face cover throughout the duration of a mission in which a potential NBC threat exists, since a face cover can be put into place very quickly. If a crew member needs to be supplied with oxygen-enriched air during certain stages of a mission, the face cover is complemented by a mouth-and-nose mask which receives the breathing gas and which is provided with a breathe-out outlet leading directly to ambient air.

In present protective devices, delivery of breathing gas to the face cover (or through the face cover to the mask), and often exhaust of gas breathed out from the face cover, via valve means, are located at the front, thereby giving rise to significant and tiring unbalance and possibly also interfering with the field of view.

The present invention seeks in particular to provide a device for protecting an individual while reducing the unbalance.

To this end, the invention provides a device in which an element worn directly on the head is provided with ducts:

one duct connecting a socket for receiving an inlet in the face cover or in the mouth-and-nose mask, to a lateral coupling for feeding breathing gas and placed behind said socket; and

the other duct connecting a socket for receiving a breathe-out air outlet to an exhaust provided with a breathe-out valve. This exhaust can likewise be lateral.

In another aspect of the invention, the device has a mouth-and-nose mask with a breathing gas admission and a breathe-out outlet provided with a breathe-out check valve and with a breathing gas coupling piece carried by an element which is distinct from the mask and worn directly on the head, the device being characterized in that the coupling piece includes a passage which can be connected in leaktight manner to the mouth-and-nose mask feed and a lateral pipe taking the connection with a breathing gas supply rearwards.

The weight of the breathing gas feed “caterpillar” hose is thus offset well back, thereby eliminating the major part of the unbalance and reducing the wearer's fatigue.

In addition, head mobility is less impeded than when the feed takes place from the front.

In an advantageous embodiment, the duct or ducts are carried by a hoop secured or securable to a hood having a large front opening leaving free the eyes, the nose, and the mouth, or to a helmet of the kind described in document FR-A-2 710 272 or U.S. Pat. No. 5,588,948.

When the device is likely to be used on board vehicles where the wearer of the device is liable to be fed with breathing gas either from the left or from the right depending on the position occupied by the wearer, it is advantageous to provide a coupling piece on the hoop which has a set of two openings at two superposed levels on either side of a midplane, the openings being closable independently of each other, being in communication with each other and with a passage, the passage of one set communicating with the feed and the passage of the other set communicating with the exhaust, the openings at one of the levels corresponding to the outlet from the face cover or the mask and the openings at the other level corresponding to the feed of the face cover or of the mask.

Another configuration that allows feed to come from the left or from the right consists in providing the hoop with a central coupling piece connected via passages to closable inlets placed on the left and on the right, and in providing the face cover with a pneumatic connector for connection with the coupling piece, breathing out then taking place via the central portion of the mask and through the hoop. Each of the mask and the hoop carries its own breathe-out valve, and the two valves operate in cascade.

The above characteristics and others will appear more clearly on reading the following description of particular embodiments, given as non-limiting examples. The description refers to the accompanying drawings, in which:

FIG. 1 is a perspective diagram showing a hoop-and-hood assembly that enables the invention to be implemented;

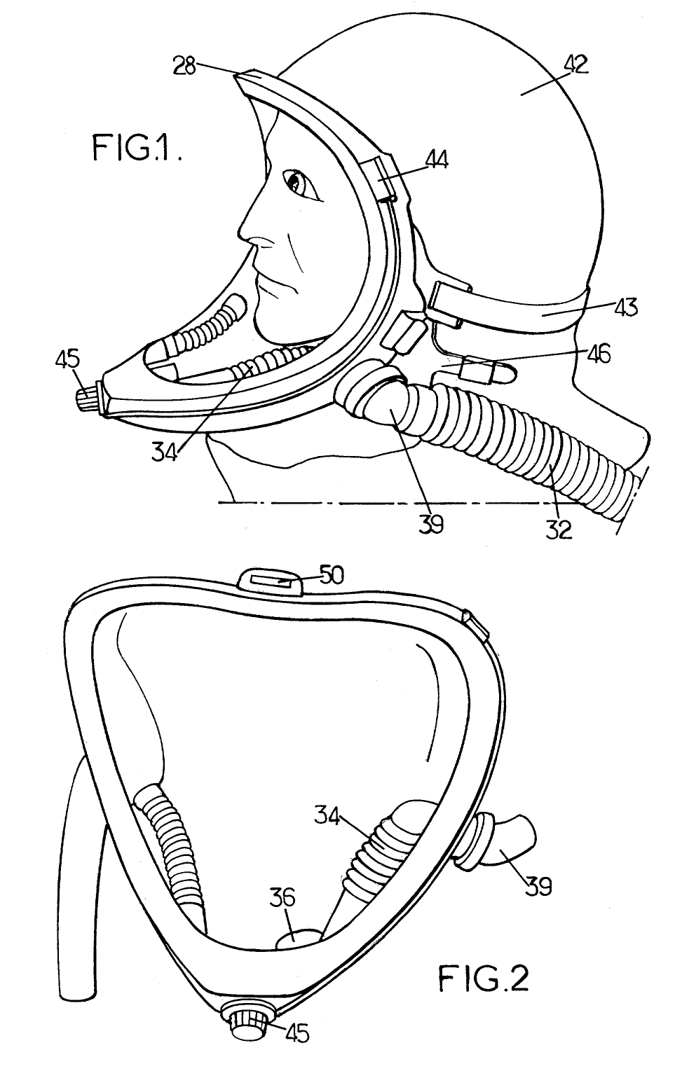

FIG. 2 is a perspective view of a hoop of the kind incorporated in the FIG. 1 assembly;

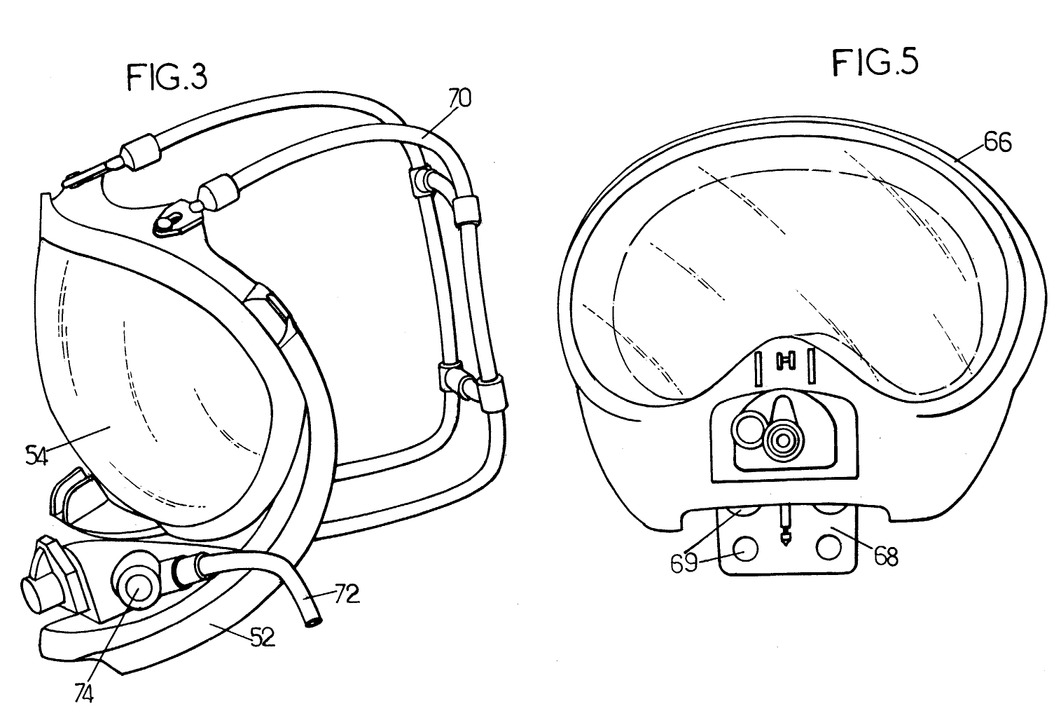

FIG. 3 shows the fittable face cover of FIG. 1 which is worn with a pneumatic harness;

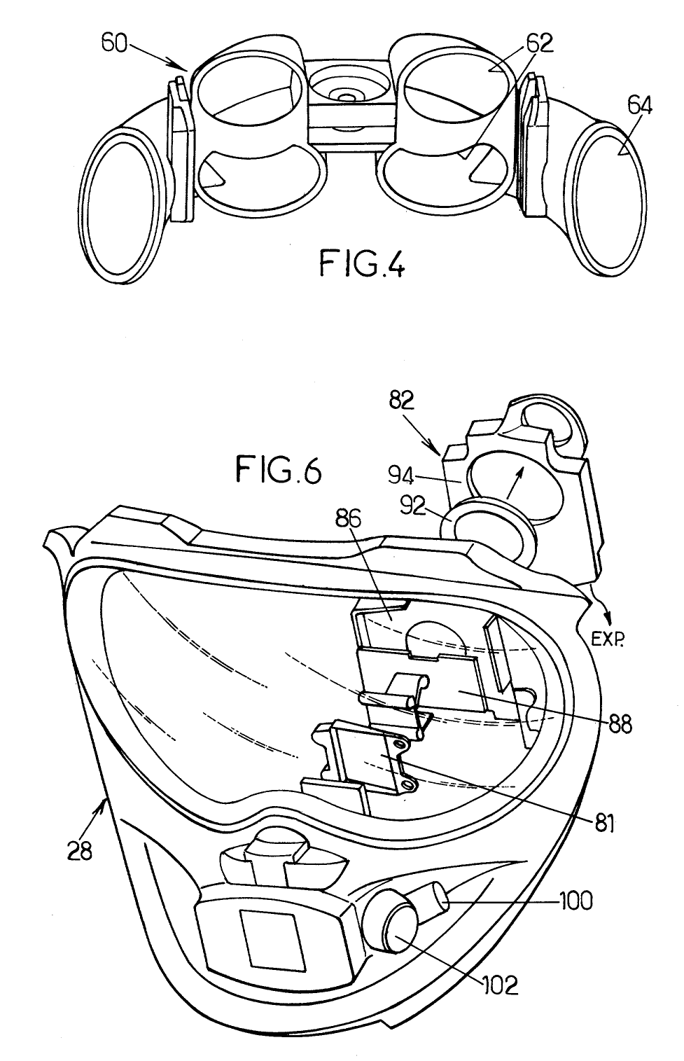

FIG. 4 is a perspective view of an example of a coupling piece for a hoop or a face cover that enables feed to take place from one side or the other;

FIG. 5 is a perspective diagram of a face cover fitted with a coupling plate for co-operating with a piece of the kind shown in FIG. 4;

FIG. 6 is an exploded perspective view of a face cover for receiving a mask and connectable to a hoop of the kind shown in FIG. 1, the cover being provided with a coupling piece of the kind shown in FIG. 4;

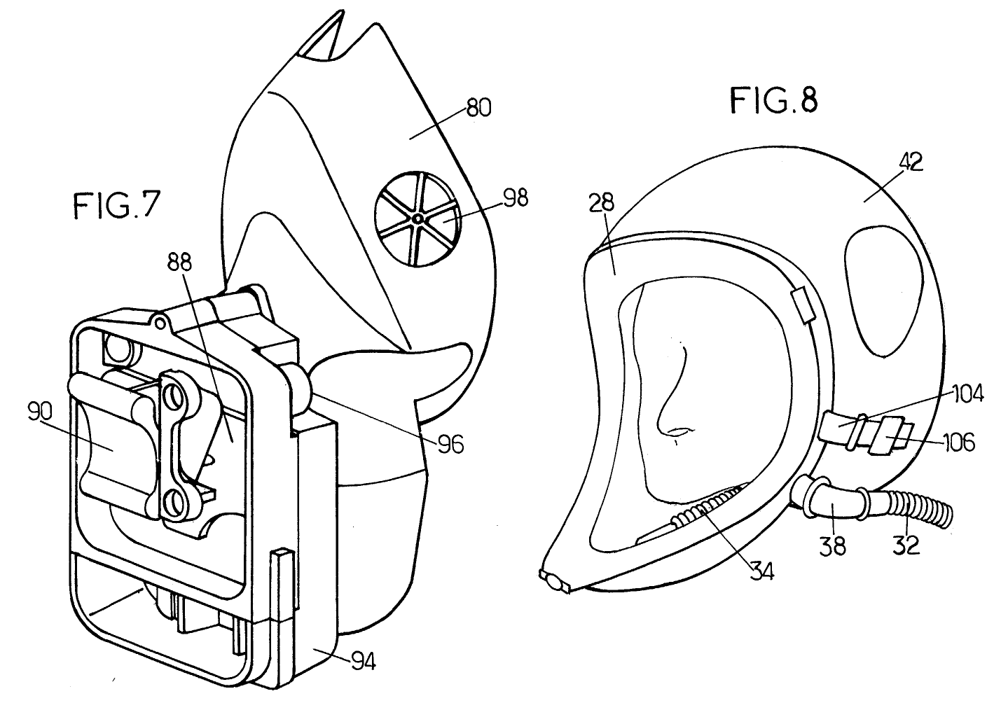

FIG. 7 is a perspective view of a mask for use with a face cover of the kind shown in FIG. 6; and

FIG. 8 shows one possible way in which the hoop can be mounted on a helmet.

The protection devices described below by way of example are generally similar in structure to those disclosed in document EP 0 885 632 or in U.S. patent application Ser. No. 09/094,498 (Bonhomme et al.) to which reference can be made. For that reason only the modifications made thereto are described in detail herein.

Before describing the various embodiments of the invention, it is appropriate to recall that different applications of the invention lead to the device having different functions:

On board a helicopter, the crew wear helmets. The helicopter operates at low altitude. During missions where there is an NBC risk, a hood must be under the helmet. So long as the risk is not imminent, the hood can remain open and the wearer can breathe ambient air. In the event of a threat, the wearer closes the opening by means of a face cover which is fed with filtered air, via a blower where necessary, and carrying a mouth-and-nose mask in which the breathe-in and breathe-out paths are separate.

On board a combat aircraft, the pilot wears a helmet and must also wear a hood in the event of an NBC risk. The opening is closed by a face cover. The pilot wears a breathing mask inside. A demand regulator, generally carried by the seat, feeds the mask with breathing gas which is enriched in oxygen at high altitude. It is also possible to use a mask provided with a removable hoop for airtight connection to the face cover and to a bib that provide full NBC protection. The removable face cover is connected to the hoop in order to provide NBC leaktightness. The hoop is secured either to the helmet or to a hood under the helmet.

On board a transport or early warning aircraft, crew members generally do not wear helmets on a continuous basis, and under such circumstances individual NBC protection is provided by a hood and a removable face cover that can be fitted with a mouth-and-nose mask, that is connectable to a hoop carried by the hood or by a special helmet. Breathing gas is provided via a demand regulator which can be carried by the seat, placed inside the face cover, or placed outside it (e.g. a chest regulator).

Whenever a blower is provided, it delivers filtered air at slightly positive pressure, it compensates for head losses due to the filtering, and it guarantees a sweeping flow of air inside the hood and/or the face cover.

The device shown in FIG. 1 can be used in particular by a crew member of a transport or surveillance airplane, who will not wear a helmet in many circumstances.

The device comprises a hood 42 which the crew member to be protected puts on before a mission that presents an NBC risk. The hood 42 is provided at the rear with a gas exhaust check valve (not visible in the figures) . The hood 42 can be tightened by a strap 43. It has a large front opening leaving clear the airways and the eyes, and this opening is encircled by a hoop 28. In the example shown in FIG. 1, the hoop is fixed in airtight manner to the hood. The hoop or the hood can be provided with a yoke 50 (FIG. 2) and/or with ratchets or pull-straps 46 for connection purposes, where necessary. The bottom portion of the hoop projects forwards. This leaves sufficient room to receive a mouth-and-nose mask. In addition, the front face of the hoop carries a gas-tight bearing piece for a face cover (not shown in FIGS. 1 and 2) that also carries the mouth-and-nose mask. The face cover can have the structure described in above-mentioned document EP 0 885 632 and can be removably applied against the hoop by various methods:

by releasable connection means;

with the help of a harness that can be inflated and deflated;

with the help of a bottom peg (FIG. 5) and snap-fastening side catches 44 that can be released by a rotary knob 45 carried by the hoop.

The face cover 66 (FIGS. 1 and 2) need not have a regulator when used on board a helicopter or on an airplane flying at low altitude and with low performance. It is designed so that its inside receives filtered air and includes a separate path for exhausting air that has been breathed out.

The hoop 28 (FIG. 1) is designed to be fed with air by means of a flexible hose or “caterpillar” 32 which connects to the side and not to the front. For this purpose, the outlet 36 of the fresh air feed inside the face cover is connected by a length of hose 34 to a bend 38 terminated by an endpiece 39. FIGS. 1 and 2 show that the bend can be offset well behind the front of the hoop, thereby reducing unbalance.

In the example shown in FIG. 1, the breathe-out path comprises elements similar to those for the breathe-in path, with a check valve and a valve in series upstream from the bend.

The face cover 66 can have the structure shown in FIG. 2. It comprises a frame 52 as shown in FIG. 3 for pressing against the hoop, and a window or screen 54 of transparent material having good optical properties. The bottom portion of the frame engages in an enlarged portion of the hoop, at the front of the hoop, so as to keep the breathe-in and breathe-out paths separate.

The face cover contains a breathing mask (not shown) having a seal that presses around the nose and the mouth and that keeps the breathe-in and breathe-out paths separate as already described in document EP A 0 885 632. The mask also receives oxygen by means of a hose that is not shown in FIGS. 1 and 2.

FIG. 3 shows a variant mount for applying the face cover to the hood and hoop assembly. The face cover is provided with a pneumatic harness 70 that is inflatable and of the same kind as shown in FIG. 4 of document EP A 0 885 632. The face cover carries a coupling 72 leading to an oxygen feed and a button 74 for inflating the harness.

Often, especially in aircraft having two seats side by side, it is not possible to specify in arbitrary manner that filtered air is to be fed from one particular side. To enable feed to take place from one side or from the other side, the end enlargement of the hoop contains a coupling piece 60 which is suitable for being fed from the left or from the right. It can be of the kind shown in FIG. 4.

This coupling piece 60 is symmetrical in structure about a vertical midplane. For example, on the right-hand side in the figure the piece 60 has two superposed openings 62 communicating with each other and with a passage 64 designed to be connected either to a segment of breathing air feed hose (delivering air or air optionally enriched in oxygen if the mask does not include a regulator). These two openings can be closed independently of each other. The bottom two openings open out into the breathe-out path of the mask. The top two openings open out into the breathe-in path. Thus, by closing one bottom opening and one top opening, it is possible to connect one or other of the passages at will to the breathing gas inlet or to the exhaust.

A face cover 66 usable with a hoop provided with a coupling piece 60 of the kind shown in FIG. 4 is shown in FIG. 5. It includes a plate 68 for inserting in the hoop and presenting four holes 69 allowing air to pass through. Simultaneously, the plate co-operates with a central peg for fixing the face cover on the hoop.

When for use on board a helicopter, no oxygen feed is provided, only a filtered air feed. Outside periods of danger, crew members wear only a hood under a helmet and can breathe freely through the large opening in the hood. When there is an NBC threat, the user puts on a face cover provided with a mask which is connected to the blower via an assembly of the kind shown in FIG. 1.

In the modified embodiment shown in FIGS. 6 and 7, the hoop 28 for connection to a hood or a mask fitted with a neck seal is designed to receive a mask 80 and to operate in two different ways, one with the mask being fed directly and with the visor of the face cover in place being ventilated by a branch connection, and another with a visor de-misting strip being fed directly and with a return towards the mask which is provided with breathe-in valves 98 for taking air from inside the face cover.

For this purpose, the face cover carries a mask-receiving box 82 (FIGS. 6 and 7) built up of several parts. The coupling block 60 for receiving the plate 68 (FIG. 5) is placed on the hoop opposite from the plate. The box 82 carries a feed plate 84 pierced by an air-passing opening. It is provided with a shutter assembly comprising a socket 86 and a flap 88 with a manual switch 90 enabling it to be moved between an open position as shown in FIG. 6 and a closed position as shown in FIG. 7.

In the open position, which corresponds to normal operation of the blower, the open flap allows air to reach a combined breathe-in and breathe-out valve comprising a membrane 92 carried by a mask coupling 94. A fraction is diverted towards the visor. The coupling has a breathe-out channel and the socket carries an outlet 98 for de-misting the visor.

When the blower breaks down or when energetic de-misting is necessary, the user closes the flap. The mask is no longer fed directly, with air penetrating therein from the face cover via the breathe-in valves 98. This makes it possible, depending on conditions of use, to perform de-misting with air that is not carrying a load of moisture due to breathing out. This is made easier by using a compensated membrane.

The face cover can be designed to be held on by a harness of the kind shown in FIG. 3 providing a supply of oxygen under pressure is available. It is then connected to an endpiece 100 and an inflation button 102 is provided.

When the device is designed for use on board a combat airplane, the pilot wears a helmet and the mask must be separate from the face cover since the mask is worn permanently. When the installation includes an external regulator, the mask is fed with breathing gas via a hose 38 and a length of hose 34 of the kind shown in FIG. 1 and mounted on the hoop 28 which is fixed to the hood.

In the variant embodiment shown in FIG. 8, the hoop 28 is fixed to the helmet 42 by prongs 104 which engage in lugs 106 carried by the helmet. This disposition can also be used during missions that do not include any NBC risk, but only a risk of oxygen deprivation and/or of smoke. Under such circumstances, the pilot does not wear a hood, but only the assembly comprising a face cover and a mask (not shown) fed by a seat regulator or by an oxygen source if the mask carries a demand regulator. All of the advantages associated with eliminating the unbalance are retained.

1. A device for breathing and possibly for providing NBC protection, the device having a mouth-and-nose mask with a breathing gas admission and a breathe-out outlet provided with a breathe-out check valve and with a breathing gas coupling piece carried by an element which is distinct from the mask and worn directly on the head,
the device being characterized in that the coupling piece includes a passage that is connectable in leaktight manner to the mouth-and-nose mask feed and a lateral pipe (34) taking the connection with the breathing gas feed (32) rearwards.

2. Equipment according to claim 1, characterized in that the connection with the outside includes a check valve.

3. Equipment according to claim 1 or claim 2, characterized in that the element distinct from the mask is constituted by a hoop provided with airtight coupling means that are permanent or releasable for closing and opening in an NBC protection hood that leaves the eyes, the nose, and the mouth disengaged.

4. Equipment according to claim 1, 2, or 3, characterized in that the breathe-out connection also includes a lateral pipe taking the connection rearwards.

5. Equipment according to any preceding claim, characterized in that it further comprises a face cover constituting a one-piece assembly with a mouth-and-nose mask provided with a demand regulator or connected thereto.

6. Equipment according to any one of claims 1 to 4, characterized in that the coupling piece is designed to be connected by a hose (32) to a seat regulator delivering a breathing mixture, and in that a fraction of said mixture is diverted into the face cover in order to ventilate it.

7. A device for protecting an individual, the device comprising a hoop secured to a hood (42) or a helmet, and optionally a face cover provided with fastenings enabling it to be pressed in airtight manner against the hoop, said hoop being provided with a hose for feeding breathing gas to the face cover or directly to a mouth-and-nose mask contained in the face cover or connectable thereto, the device being characterized in that an element worn directly on the head is provided with a duct connecting a socket for receiving an inlet in the face cover or the mouth-and-nose mask to a lateral coupling for supplying breathing gas and placed behind said socket.

8. A device according to claim 7, characterized in that said element also carries a socket for receiving a breathe-out air outlet leading to a lateral exhaust provided with a breathe-out valve.

9. A device according to claim 7 or claim 8, characterized in that a coupling piece is provided on the hoop having, on either side of a midplane, two superposed openings that are closable independently of each other, that communicate with each other and with a respective passage, one of the passages communicating with the feed and the other with the exhaust, the openings at one of the levels corresponding to the outlet from the face cover or the mask and the openings at the other level corresponding to the feed for the face cover or the mask.

10. A device according to claim 7, characterized in that with the hoop secured to a helmet, said feed pipe is connected firstly to a seat regulator and secondly directly to the mask.

11. A device according to claim 7 without an oxygen feed, the device being characterized in that the breathing gas feed, where the breathing gas is constituted by filtered air provided by a blower, is connected to switch means enabling it to be delivered either to the mouth-and-nose mask or to the face cover and via the face cover to the mask.
